(19) United States
(12) Patent Application Publication
(10) Pub. No.: US 2008/0004960 A1
(43) Pub. Date: Jan. 3, 2008

(54) Interactive promotional space in a discovery interface

(75) Inventors: Christen Coomer, Seattle, WA (US); Daniel L. Poling, Woodinville, WA (US); Michael W. Van Flandern, Seattle, WA (US); Frederic Azera, Kirkland, WA (US); Jeffrey C. Fong, Seattle, WA (US)

Correspondence Address: MICROSOFT CORPORATION, ONE MICROSOFT WAY, REDMOND, WA, 98052-6399, US

(73) Assignee: Microsoft Corporation Microsoft Patent Group, Redmond, WA (US)

(21) Appl. No.: 11/479,275

(22) Filed: Jun. 30, 2006

(51) Int. Cl. G06Q 30/00; H04N 7/10

(52) U.S. Cl. 705/14; 725/32

(57) ABSTRACT

A discovery interface including an interactive promotional space is provided. In one implementation, for example, a discovery interface includes links to promotional portals of individual content providers. A user can select one of the links to be redirected to a promotional portal of a content provider. The promotional portal includes a space through which the user may access additional offerings of the content provider. The promotional portal, for example, may include links, such as interactive thumbnails, to additional media content offered by the content provider.

### BACKGROUND

The convergence of computing and entertainment continues to provide new content and options for consumers. For example, cable subscribers can now access cable television programs and video-on-demand content (VOD) through their set-top boxes. In one offering, video-on-demand service allows a user to select a program for viewing from a library of programs, wherein all of the programs are available at any time and can be paused, saved, reviewed, etc. (as opposed to a cable television program that is only available at a scheduled time and duration). Other sources of content may also exist, including content from a media library, an Internet Protocol (IP) stream, a Web site, etc.

Consumers and content providers can find great benefit in the availability of content from so many different types of sources. For example, a consumer can view a rerun episode of a cable television program and then search for and view a subsequent episode of the same program over VOD or some other content providing channel. For their part, content providers can keep people “tuned in” with a wider assortment of content and content types.

Listings of available programs for a given content source are generated from discovery data (e.g., catalogs of available programming). However, existing approaches for presenting a user with choices of available content tend to isolate the choices based on the specific source of the content. For example, a typical electronic program guide (EPG) provides cable television listings through one interface and video-on-demand content listings through a separate and distinct interface. The single-minded approach to such EPGs limits the flexibility available in the EPG for promotional interaction between the content provider and the viewer.

### SUMMARY

Implementations described and claimed herein address the foregoing problems by providing a discovery interface including an interactive promotional space through which a content provider can interact with the view for promotional purposes. In one implementation, for example, a discovery interface includes a navigational control to promotional portals of individual content providers. One example of a navigational control may include a link to the promotional portal, such as a hypertext link. A user can select one of the links to be redirected to a promotional portal of a content provider. Another example of a navigational control may include an interactive control that executes functionality of the EPG or another application that provides access to the promotional portal of the content provider. For example, the functionality may provide a modified EPG screen with a promotional portal window defined by the content provider. In these and similar manners, promotional portal can be provided to include a space through which the user may access additional offerings of the content provider that were not available in the discovery interface. The promotional portal, for example, may include links, such as interactive thumbnails, to additional media content and services offered by or through the content provider.

In one particular implementation, the promotional portal of a content provider includes media content related to a particular media content offering available through the discovery interface (e.g., time-based programming). For example, having navigated to a broadcast channel listing at a particular timeslot, the viewer may be presented with an animated promotional region in the discovery interface in the proximity to the current navigation position. If the current navigation position is on a listing for a reality television show, the promotional space can display a promotional graphic, text or animation promoting another reality television show. Likewise, the media content available through the promotional portal may be contextually-related, temporally-related, demographically-related or otherwise related to media content available through the discovery interface. As such, the promotional portal associated with the reality television promotional space can emphasize available content believed to be of interest to viewers of reality television shows. Thus, by providing media content targeted to an audience of particular content, a content provider may leverage the interest of the audience to promote additional media content likely to be of interest to that audience. In addition, the user may have access to additional media content she that might otherwise been inaccessible or unknown.

In some implementations, articles of manufacture are provided as computer program products. One implementation of a computer program product provides a computer program storage medium readable by a computer system and encoding a computer program. Another implementation of a computer program product may be provided in a computer data signal embodied in a carrier wave by a computing system and encoding the computer program. Other implementations are also described and recited herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example system for presenting an interactive promotional space in a discovery interface.

FIG. 2 illustrates an example screenshot of a discovery interface including an interactive promotional space.

FIG. 3 illustrates an example implementation of a system for providing a discovery interface including an interactive promotional space.

FIG. 4 illustrates example operations for providing an interactive promotional space in a discovery interface.

FIG. 5 illustrates an example system that may be useful in implementing the described technology.

### DETAILED DESCRIPTIONS

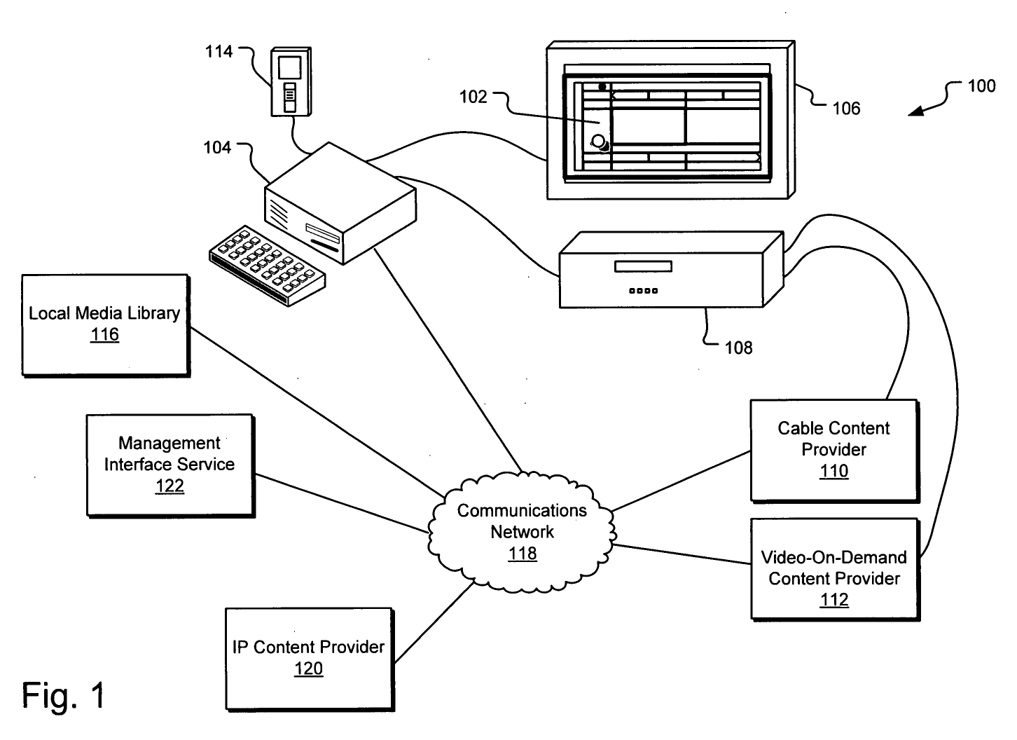

FIG. 1 illustrates an example system 100 for presenting discovery data pertaining to media content offered by a content provider and promotional links of that content provider in a discovery interface 102. A user's computing system 104 is coupled to a display device 106, which is capable of presenting the unified discovery interface 102. The computing system 104 is also coupled to a tuner device 108 (e.g., a set-top box or a tuner card internal to the computing device), which communicates with a cable content provider 110 and a video-on-demand content provider 112. It should be understood that the cable content provider 110 and the video-on-demand content provider 112 may be represented by the same entity. Furthermore, content providers that compete with the cable providers, such as satellite services and airwave-based broadcast television stations, may also be supported in a similar manner. Content providers for other media, such as satellite radio, broadcast radio, etc., may also be supported through computing system 104.

In one implementation, the computing system 104 executes a media application that manages the user's access to media content, whether available locally or remotely. For example, the user can use his or her computing system 104 to control a portable media player 1 14, the tuner device 108, a local media library 116, and other content available from discrete devices or over a communications network 118. Examples of the control a user may apply can include without limitations transferring content between a portable media player 114 and a local media library 116, scheduling the recording of a cable television program by a digital video recorder (not shown) coupled to the computing system 104, downloading IP content (such as a video or song) from an IP content provider 120.

In one implementation, the media application also provides the discovery interface 102 on the display device 106 (e.g., a monitor or television) coupled to the computing device 104. Discovery data is obtained through a media information service 122 that collects program information about content from a variety of sources. The media information service 122 maps discovery data from a variety of sources to one or more consistent schema, enabling a consistent discovery experience, and associates content from different sources. The discovery interface 102 can be represented by an on-screen guide, such as an electronic program guide (EPG), although various monikers may be used in other implementations, including without limitation interactive program guide (IPG) and electronic service guide (ESG). The discovery interface 102 presents an on-screen guide to the available content (e.g., scheduled cable television programs, available IP content, locally stored media, etc.) and also presents an interactive promotional space including at least one link to a promotional portal of a content provider.

In one implementation, the discovery interface 102 provides a graphical user interface that can display program titles and other descriptive information (collectively “discovery data”), such as a summary, actors' names and bios, directors' names and bios, year of production, etc. In one implementation, the information is displayed on a grid with the option to select more information on each program, although other formats are also contemplated. Channel identifiers pertaining to the scheduled cable programs, the program start and end times, genres, thumbnail images, and other descriptive metadata can also be presented within the discovery interface 102. Radio and song information may offer other information, such as artist, album, album cover graphics, and track title information. The discovery interface 102 allows the user to browse program summaries; search by genre, channel, etc.; and obtain immediate access to the selected content, reminders, and parental control functions. If the computing device 104 is so configured or so connected, a discovery interface 102 can provide control for scheduled recording of programs.

A user can use the discovery interface 102 to navigate, select, and discover content by a variety of parameters, including time, title, channel, genre, cost, actors, directors, sources, relationships to other content, etc. Navigation can be accomplished through the media application by a variety of input devices, such as a remote control, a keyboard, and a mouse. In one implementation, for example, the user can navigate through the discovery interface 102 and display information about scheduled cable programs, video-on-demand programs, and associated IP content within a single presentation frame. By navigating through the discovery interface 102, the user can manipulate and obtain more information about a current program or about other programs available through the discovery interface 102. For example, when the computing device 104 is connected to a DVR, the user can to plan his or her viewing schedule, learn about the actors of available programs, and record cable programs to a hard disk in the computer device 104 for later viewing.

A promotional portal of a content provider may include any number of portals through which a user may obtain additional information or media content provided by the content provider (and possibly one or more associated providers). The promotional portal can be interactive (e.g., a graphical user interface) or may merely present additional information (e.g., an advertisement) to the user.

In addition, the promotional portal could be external to a host application of the discovery interface (e.g., a web site on the Internet) or may be internal to the discovery interface (e.g., a template with the host application). In one implementation, for example, the promotional portal includes a web browser that opens a web page using the link (e.g., a uniform resource indicator (URI), such as a uniform resource locator (URL)) through which the user can interact to obtain additional information or media content available through the web page. In another implementation, the link of the interactive promotional space may include a control that activates a promotional screen. The promotional screen, for example, may include a web browser, a media player (e.g., a flash player, an MP3 player, a picture viewer, a text box), a link to additional content, or any other application that can present information and/or media content to the user within the promotional screen or through another interface. Information presented to a user through the promotional portal, for example, may include media content available to the user through the promotional portal, metadata relating to the additional media content, links (e.g., thumbnails or URLs) to additional information or media content, advertising, or any other information the content provider wants to provide to the user through its own private interactive promotional space. Information may include many different formats, such as video, still pictures, animation, graphics, text, and the like.

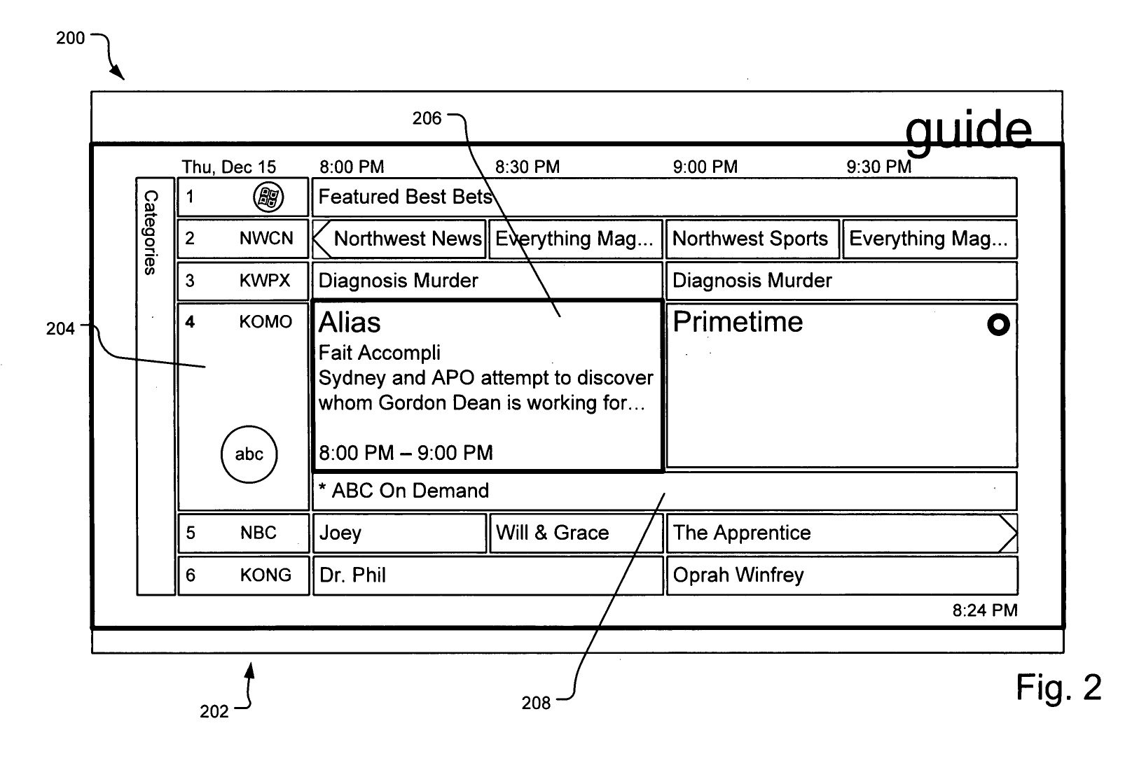

FIG. 2 illustrates an example screenshot 200 of a discovery interface presenting media content and a link to a promotional portal of a content provider. A grid presentation frame presented in the discovery interface includes rows associated with specific broadcast/cable content providers (e.g., networks, local broadcast stations, etc.) and columns associated with designated time slots. The first column 202 identifies the content provider in a selectable promotional region (see e.g., the promotional region 204). By selecting the promotional region 204, a user can navigate to a promotional portal that provides more information about the content provider's offerings.

In the 8:00 PM-9:00 PM time slot for channel “4”, a broadcast content region 206 presents a listing for the program “Alias”, with metadata describing the episode title and an episode summary. By selecting the broadcast region 206, the user can gain access to functionality for changing the viewing channel to channel “4,” scheduling a reminder to watch “Alias” at 8:00 PM on Thursday, scheduling a recording of the “Alias” episode, and a variety of other actions. [00221 The bold line around the broadcast content region 206 indicates that the user has navigated to the broadcast content region 206. As such, an IP content region 208 associated with the content provider shown in the promotional region 204 can be presented below the broadcast content region 206. Such a co-location of the content provided by the same content provider allows the content provider to provide a “branded” package presentation of content available for delivery to the user in a single space of the discovery interface. Similarly, it allows the user to easily find content provided by a favorite content provider in the single space.

The promotional region 204 includes a navigational control (such as a hypertext link or other control) to a promotional portal of the content provider (e.g., ABC). The promotional portal of the content provider provides additional information, services, and/or media content offered by the content provider.

The navigational control may be related to particular media content of the content provider shown or selected in the discovery interface. In the screen shot 200 of FIG. 2, for example, the bold line indicates that the user has selected the broadcast content region 206 corresponding to an “Alias” episode available on channel “4” from ABC at 8:00 PM to 9:00 PM. In this example, the promotional region may include a navigational control to a promotional portal that includes contextual, temporal, demographic, parental ratings, or other relations to the “Alias” episode, the time segment, or other aspects of the selected broadcast content region 206.

Thus, navigational controls to different promotional portals may be provided by the content provider ABC depending on various aspects of the discovery interface. The associated promotional portal may provide access to other contextually-related media content, such as other “Alias” episodes or other media content including common subject matter or genre, temporally-related media content, such as other programs typically broadcast in similar time windows, demographically-related media content, such as content directed to viewers in certain age groups (e.g., a viewer browsing through Nickelodeon and/or Cartoon Network broadcast programming may see IP content directed to viewers in the 5-14 year old age group), or parental ratings-related media content, such as media content having similar parental ratings as those set up for a user on the computing system.

When a user activates a navigational control (e.g., selects a link) to a promotional portal offered by a content provider in the promotional region 204, the navigational control directs the discovery interface to a promotional portal offered by the content provider. The navigational control may, for example, include a uniform resource indicator (URI), such as a uniform resource locator (URL) or other link that identifies the promotional portal associated with the promotional region 204 of the discovery interface. The user may continue to navigate within the promotional portal to access further media content or information related to media content provided by the content provider. This provides the content provider the ability to market its offerings and other associated offerings to users within its own space as part of a discovery interface. It also provides the user the ability to more easily find additional information and media content, which may be related to particular interests of the user.

In another implementation, the URI may include a parameter (e.g., be appended by a parameter) that provides a context to the promotional portal. The parameter may provide context, for example, through a content type, a temporal indication, a demographic indication, a geographic indication (e.g., a zip code), or any other context-related information. Thus, the content provider may provide different sections or pages of the promotional portal depending upon the parameter received with the URI. The different sections or pages of the portal can be used to provide a contextually relevant landing to the user depending on what was being viewed in the discovery interface (e.g., more of the same content, similar content, extended content, content community, download applications, and the like). For example, if a particular show is being offered by the content provider at the time the user is viewing the discovery interface, a parameter provided with the URI can be used to navigate the user to a series page for that show within the promotional portal. In another implementation, a zip code or other geographic parameter may be used to permit a content provider to direct a user to a local content provider (e.g., a network affiliate) or to include affiliate or local ads in the promotional portal and/or in content provided by the content provider via the promotional portal.

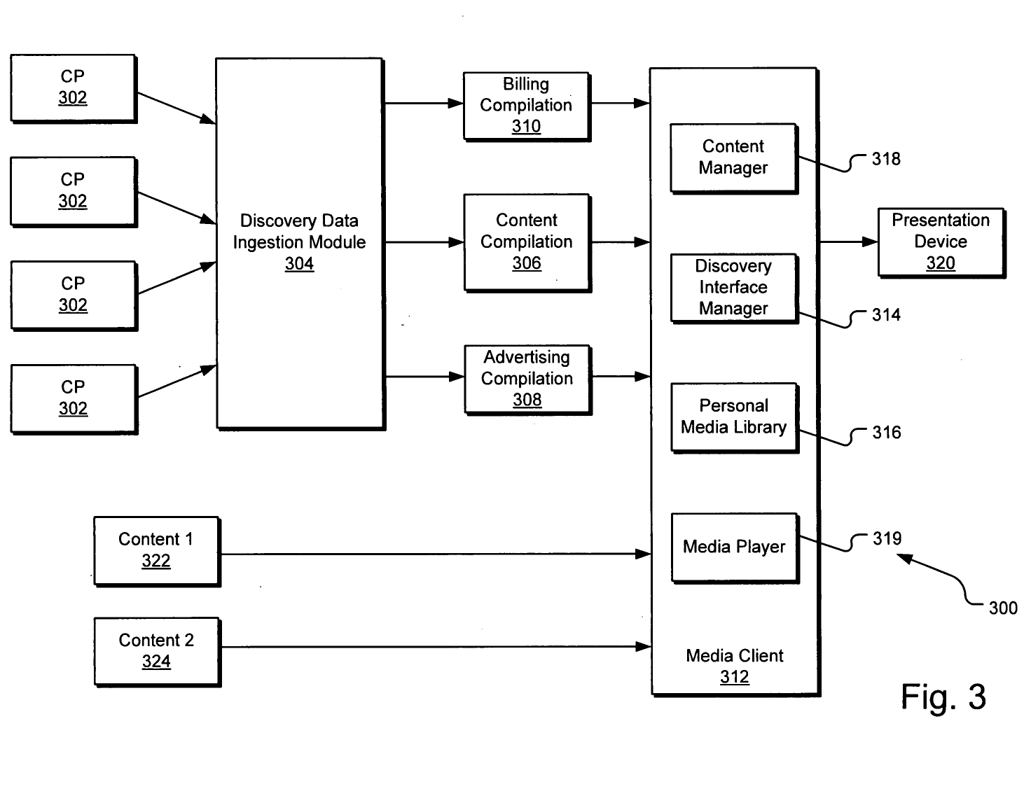

FIG. 3 shows an example implementation of a system 300 for providing a discovery interface including at least one navigational control to a promotional portal of a content provider. In this implementation, one or more content providers 302 provide discovery data to a discovery data ingestion module 304. The discovery data ingestion module 304 aggregates the discovery data into one or more content compilations 306 (such as a catalog, an index, a database, etc.), one or more promotional compilations 308, and/or one or more billing compilations 310.

The metadata ingestion module 304, for example, can receive discovery data, such as metadata related to an interactive promotional space or media content provided (or to be provided) by a content provider. Metadata may include, without limitation, descriptive properties of media content or descriptive properties of how the content is integrated within the unified discovery interface. Metadata describing media content, for example, may include title, synopsis, genre, category, classification, review, cast, crew, artist, producer, time, duration, location, content type, content provider, source, resolution, cost, subscriber, or other data relating to particular media content. Metadata describing integration within the discovery interface may include without limitation descriptions of the contextual, demographic, or parental ratings relationships of the content with other content. For example, contextual relationships may associate content directed to a common subject matter (e.g., World War II) or genre (e.g., “The 4400”, “The X-files”). Demographic relationships may associate content directed to viewers in certain age groups (e.g., a viewer browsing through Nickelodeon and/or Cartoon Network broadcast programming may see IP content directed to viewers in the 5-14 year old age group). Parental ratings relationships may prevent the display of IP content based on parental controls set up on the computing system.

In one implementation, a content provider provides metadata associated with the discovery data to define an interactive promotional space. Such metadata may include without limitation a graphical image, animation data, a hypertext link, and location and size information (of the region occupied by the interactive promotional space). The metadata is received by the discovery data ingestion module 304 and passed into a content compilation 306 for use in generating a discovery interface.

Cable television providers, for example, provide content discovery data specifying programming details available for electronic programming guides. Likewise, available IP content can be collected into catalogs using web crawlers, search engines, predetermined offerings catalogs, etc. Such discovery data can then be combined into the content compilation 306 for display and activation within the unified discovery interface.

In one implementation, a content provider (such as one of the broadcast television networks) can provide metadata defining a graphical image (the CBS “eye” and text) and a navigational control (e.g., a hypertext link to a promotional portal for CBS content and services). The navigational control may be dynamic and context-sensitive in that a different hypertext link, for example, may be activated depending on the listing at which the viewer had previously navigated within the discovery interface. Furthermore, other system properties may influence which graphical images and links are active for a given interactive promotional space. For example, parental controls may be used to limit the content available through an available promotional portal.

The discovery data ingestion module 304 also receives promotional discovery data including at least one navigational control to a promotional portal through which the content provider offers additional media content and/or information. The content providers, for example, may provide URLs or IP addresses to web sites providing additional content that can be accessed as a promotional portal via the URLs or IP addresses. Promotional discovery data may also include, for example, additional media content or information relating to that media content or advertising information that may be presented within the discovery interface or a promotional portal. The promotional discovery data may be used, for example, to provide promotional portals related to aspects of the discovery interface and potentially to tailor advertisements for individual viewers or families, in a similar manner as cookies for web sites. Such promotional discovery data can then be combined into the promotional compilation 308 for use in accessing and/or hosting a promotional portal.

Other types of discovery data, such as billing data may be provided to the discovery data ingestion module 304. Billing data, for example, may be used to process financial transactions through the discovery interface, such as a viewer purchasing media or ordering VOD content. The billing data may be combined into the billing compilation 310 (such as a catalog, an index, a database, etc.). Information from the billing compilation 310 may be provided to or otherwise accessible by a media client 312 to authorize a purchase of media content where required within the discovery interface or a promotional portal.

The media client 312 receives the discovery data from the one or more content compilations 306, promotional compilations 308, and/or billing compilations 310. A discovery interface manager 314 of the media client 312 presents a discovery interface to a user to provide the user with a choice between media content and at least one navigational control to a promotional portal of a content provider available via a discovery interface. When a user selects particular media content from the unified discovery interface, a content manager 318 receives the content media and presents the content media to a media player 319 and then ultimately to the user on a presentation device 320. The content manager 318 may, for example, receive the media content from a personal media library 316 and/or content sources 322 and 324 associated with one or more of the content providers 302.

The content compilation 306 may, for example, contain metadata that defines an actual media content source, such as a unique identifier for that content, a source type (e.g., television or IP), and a method or protocol for accessing or retrieving the metadata (e.g., a tuning request for a live television program or an HTTP GET request and a URL to the content on an Internet server for IP content). When the user selects a particular media content via the discovery interface, the discovery interface manager accesses the metadata associated with the media content from the content compilation 306, such as using an ID reference and launches the appropriate content retrieval function based on its source type and access method. The content compilation 306 may also include metadata that allows the media client 312 to determine which promotional link is displayed (e.g., on a broadcast or other channel). For example, if a user selects the show Alias from channel 4, the content manager 318 directs an NTSC tuner to receive the Alias broadcast. Likewise, if the user selects the Lost episode from ABC.com, the content manager 318 establishes an appropriate video stream from the specified URL. If the user selects to purchase the episode of Lost from CinemaNow or Movielink, the content manager 318 initiates a download from the specified URL.

In one particular implementation, for example, the content compilation 306 includes a source field for each content entry. The source field may indicate a content delivery type (e.g., broadcast delivery or IP content delivery), which can be used to direct the content manager 318 to an appropriate source for the selected content. In addition, a promotional link to a promotional portal of the content provider can also be matched to the source field of the content compilation 306. For example, an ABC source field may be used to map ABC promotional links to ABC content. The discovery interface manager 314 of the media client 312 may also be used to determine which, if any, of the channels should receive a promotional link to a promotional portal. For example, the promotional link may only be used for the first affiliated channel in the discovery interface or only for the local affiliate, if multiple affiliates are included in the interface. In addition, the discovery interface manager 314 may also be used to block certain promotional links from appearing within the discovery interface, such as where promotion of content is blocked by a content provider.

Media content available via the discovery interface may be delivered, for example, via one or more of many media content delivery types, such as time-based programming content, delivery, Internet protocol content delivery, analog terrestrial content delivery, digital terrestrial content delivery, pay television broadcast content delivery, video-on-demand content delivery, digital video recorder content delivery, digital video disc content delivery, compact disc music content delivery, video cassette recorder content delivery, platform partner content delivery, web content delivery, longtail content delivery, and other types of remote media content delivery. Local media content, such as available via the personal media library 316, may also be included in a discovery interface.

A user can select particular media content for presentation from the discovery interface. The download manager 318 residing on the media client 312 receives the selected media content and presents it on the presentation device 320 via a content player interface (not shown). The selected media content, for example, may be received from a remote content source 322 or 324. The remote content sources 322 and 324 may, for example, be associated with one or more content providers 302 or may be accessible from other content providers, such as longtail content providers accessible via the Internet or another WAN. Television or radio programming media content, for example, may be received and selected via a tuner in the media client 312 from a broadcast media content source, a cable source, a satellite source, or other type of television or radio media content delivery. Internet protocol media content may also be received from a server via a network, such as the Internet. Other types of media content delivery are also contemplated.

The discovery interface manager 314 also provides at least one navigational control to a promotional portal of a content provider, such as a link embedded within a graphical image in the promotional region of the discovery interface. When a user activates the navigational control, such as by selecting the promotional region of the discovery interface or entering a code (e.g., pressing a button or keystroke on a human interface device (HID)), the discovery interface manager 314 uses the navigational control to redirect the user to a promotional portal and presents that portal on the presentation device 320. The promotional portal may include a template served with information (e.g., metadata) relating to media content currently available directly through the discovery interface (e.g., time-based programming content shown in the discovery interface) and additional media content (and information related to that media content) hosted by the content provider via the promotional portal. In this implementation, for example, the template and/or the information related to the media content available directly via the discovery interface may be hosted locally by the media client 312, while the additional media content available via the promotional portion is hosted remotely by the content provider. In another implementation, a promotional portal is hosted exclusively by the content provider. In this implementation, the content provider has a greater ability to differentiate its promotional portal from other content providers to strengthen its branding and the like. The content provider may host a portion of the template or its own independent promotional portal, for example, via a scripting or markup language such as HTML, XML, or the like. Other implementations are also contemplated.

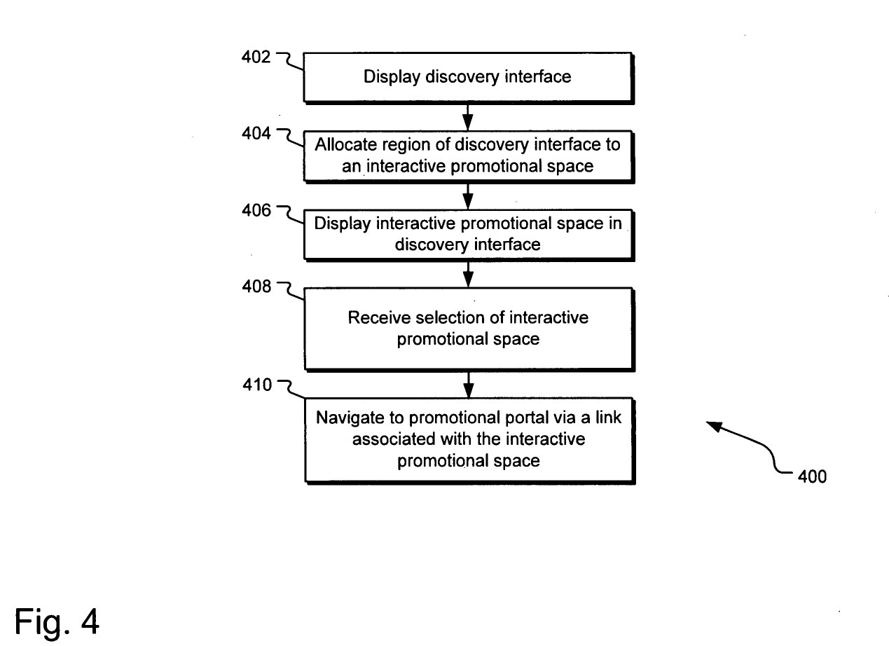

FIG. 4 illustrates example operations 400 for providing an interactive promotional space in a discovery interface. A discovery interface is displayed in a display operation 402. In one implementation, for example, the discovery interface includes a graphical user interface that displays titles and other descriptive information on a grid in which channel identifiers are shown on one axis and time is shown on the other axis. The discovery interface allows a user to browse through media content and select content for presentation.

A region of the discovery interface is allocated to display an interactive promotional space in an allocation operation 404. The allocation of the region of the discovery interface, for example, may include assigning the interactive promotional space to a particular segment of the discovery interface, such as a particular grid, row, and/or column location within the discovery interface. The placement of the interactive promotional space within the discovery interface may be hardcoded or defined by metadata provided by the content provider. The interactive promotional space includes an associated navigational control to a promotional portal of the content provider. The associated navigational control may include a URI, URL, or other link to the promotional portal. The interactive promotional space may also vary depending upon one or more contexts associated with the discovery interface. Thus, the interactive promotional space may be changed within the discovery interface depending upon where the user has navigated (e.g., which channel or media content listing has been highlighted in the discovery interface) or based on other information, such as the time and/or day, viewing habits of user logged onto the system, or the like.

The interactive promotional space is displayed in the allocated region of the discovery interface in a display operation 406. The interactive promotional space, for example, may include text, graphics, animation, or the like. In one implementation, the interactive promotional space includes a logo of the content provider supplying the content of media content available for selection in the discovery interface.

The selection of the interactive promotional space is received in a selection operation 408. The interactive promotional space can be selected by a user, for example, by highlighting the region of the discovery interface allocated to the interactive promotional space or by providing some other control code (e.g., selecting a button or keystroke of an HID.

The discovery interface, in response to the selection of the interactive promotional space, then navigates to the promotional portal via the associated navigational control in a navigation operation 410. The discovery interface, for example, may open a browser or other application that directs the user to the promotional portal via the associated navigational control.

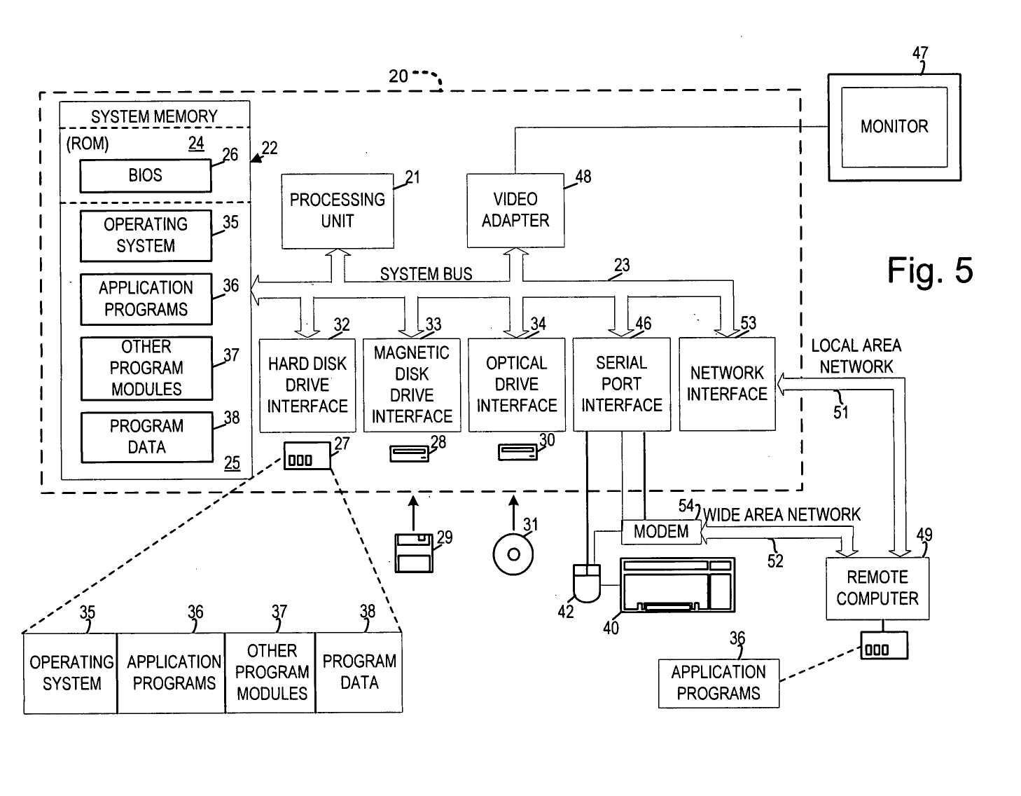

The example hardware and operating environment of FIG. 5 for implementing the invention includes a general purpose computing device in the form of a gaming console or computer 20, including a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, random access memories (RAMs), read only memories (ROMs), and the like, may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the invention is not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 6. The logical connections depicted in FIG. 6 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are example and other means of and communications devices for establishing a communications link between the computers may be used.

In an example implementation, a discovery data ingestion module, a download module, a discovery interface module, and other modules may be embodied by instructions stored in memory 22 and/or storage devices 29 or 31 and processed by the processing unit 21. A personal media library, various catalogs and content, and other data may be stored in memory 22 and/or storage devices 29 or 31 as persistent datastores.

The technology described herein is implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of example embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understood that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

Although the subject matter has been described in language specific to structural features and/or methodological arts, it is to be understood that the subject matter defined in the appended claims is not necessarily limited to the specific features or acts descried above. Rather, the specific features and acts described above are disclosed as example forms of implementing the claimed subject matter.

What is claimed is:

1. A method of providing an interactive promotional space within a discovery interface, the method comprising:
displaying a discovery interface that presents media content available from a content provider; and
allocating a region of the discovery interface to display an interactive promotional space, wherein the interactive promotional space comprises an associated navigational control to a promotional portal of the content provider.

2. The method of claim 1 further comprising displaying the interactive promotional space in the region.

3. The method of claim 2 further comprising receiving a selection of the interactive promotional space and navigating to the promotional portal via the associated navigational control.

4. The method of claim 1, wherein the associated navigational control comprises a uniform resource indicator that redirects the discovery interface to the promotional portal.

5. The method of claim 1 wherein the associated navigational control is contextually related to discovery data of the media content presented in the discovery interface.

6. The method of claim 1 wherein associated navigational control is demographically related to discovery data of the media content presented in the discovery interface.

7. The method of claim 1 wherein associated navigational control is temporally related to discovery data of the media content presented in the discovery interface.

8. The method of claim 1 wherein associated navigational control is geographically related to discovery data of the media content presented in the discovery interface.

9. The method of claim 1 wherein the promotional portal comprises navigational controls to additional media content available from the content provider.

10. The method of claim 1 wherein the promotional portal comprises an advertisement of the content provider.

11. The method of claim 1 wherein the interactive promotional space changes depending on a context of the discovery interface.

12. The method of claim 1 wherein the associated navigational control of the interactive promotional space changes depending on a context of the discovery interface

13. A method of providing an interactive promotional space within a discovery interface, the method comprising:
displaying a discovery interface that presents media content available from a content provider; and
allocating a region of the discovery interface to display an interactive promotional space, wherein the interactive promotional space changes depending on a context of the discovery interface.

14. The method of claim 13 wherein the context of the discovery interface comprises a time of day.

15. The method of claim 13 wherein the context of the discovery interface comprises a selected media content presented within the discovery interface.

16. The method of claim 13 wherein the interactive promotional space comprises a navigational control that changes depending on the context of the discovery interface.

17. A media content delivery device for providing an interactive promotional space within a discovery interface, the user content delivery device comprising:
a discovery interface that presents media content available from a content provider, wherein a region of the discovery interface is allocated to display an interactive promotional space, the interactive promotional space comprising an associated navigational control to a promotional portal of the content provider; and
a content player interface that provides selected media content for presentation.

18. The media content delivery device of claim 17 further comprising a tuner for selecting between a plurality of individual time-based programming content presented within the discovery interface.

19. The media content delivery device of claim 17 wherein the interactive promotional space changes depending on a context of the discovery interface.

20. The media content delivery device of claim 17 wherein the navigational control comprises a uniform resource identifier.
